(19) United States
(12) Patent Application Publication
(10) Pub. No.: US 2026/0196006 A1
(43) Pub. Date: Jul. 9, 2026

(54) METAVERSE SYSTEM FOR ADJUSTING VIRTUAL REPRESENTATION OF VIRTUAL OBJECT IN VIRTUAL SERVICE ENVIRONMENT AND METHOD OF OPERATING THE SAME

(71) Applicant: Electronics and Telecommunications Research Institute, Daejeon (KR)

(72) Inventors: Yong-Woon KIM, Daejeon (KR); Sung Hei KIM, Daejeon (KR); KYOUNGJAE SUN, Daejeon (KR); Sangkeun YOO, Sejong-si (KR); Changkyu LEE, Daejeon (KR)

(73) Assignee: Electronics and Telecommunications Research Institute, Daejeon (KR)

(21) Appl. No.: 19/439,698

(22) Filed: Jan. 5, 2026

(30) Foreign Application Priority Data
Jan. 6, 2025 (KR) 10-2025-0001545
Dec. 11, 2025 (KR) 10-2025-0196401

(51) Int. Cl. G06T 19/20; G06F 3/14; H04L 65/1069; H04L 65/1089

(52) U.S. Cl. CPC G06T 19/20; G06F 3/1454; H04L 65/1069; H04L 65/1089; G06T 2200/24; G06T 2219/024; G06T 2219/2012; G06T 2219/2016; G06T 2219/2021

(57) ABSTRACT

A metaverse system for adjusting a virtual representation of a virtual object and a method of operating the same are provided. The method of operating the metaverse system includes receiving a request for remote maintenance assistance of selected equipment from a worker via an augmented reality (AR) interface, in response to the request for remote maintenance assistance, synchronizing a view of an expert participating in a remote maintenance session in a virtual world with a digital twin of the equipment, and adjusting a virtual representation of a virtual object in accordance with the expert simulating an operation of the equipment through the virtual object corresponding to the digital twin in the virtual world.

### CROSS-REFERENCE TO RELATED APPLICATIONS

This application claims the benefit of Korean Patent Application No. 10-2025-0001545, filed on Jan. 6, 2025, and Korean Patent Application No. 10-2025-0196401, filed on Dec. 11, 2025, in the Korean Intellectual Property Office, the entire disclosures of which are incorporated herein by reference for all purposes.

### BACKGROUND

### 1. Field of the Invention

The disclosure relates to a metaverse system for adjusting a virtual representation of a virtual object and a method of operating the same.

### 2. Description of the Related Art

A digital twin is a technology that generates a computerized replica of a real-world object, simulates potential real-world situations, and predicts an outcome. Digital twins are gaining attention as a technology that may solve a wide range of industrial and social issues, not just manufacturing.

A digital twin is essentially a combination of data representing a structure, context, and action of various physical systems. A digital twin may be considered an operating entity that may understand past and present operational states and predict future outcomes. Digital twins are powerful digital entities that may be used to optimize the physical world, improving operational performance and business processes.

The above description has been possessed or acquired by the inventor(s) in the course of conceiving the present disclosure and is not necessarily an art publicly known before the present application is filed.

### SUMMARY

Embodiments may generate a virtual object, corresponding to a physical object, in the real world, based on data related to the physical object, with virtual representations adjusted according to an intended service purpose in the virtual world.

Embodiments may adjust the virtual representation of a virtual object corresponding to selected equipment for remote maintenance assistance in the virtual world, based on an expert simulating an operation of the equipment.

Other aspects and advantages of the invention will become apparent and more readily appreciated from the following description of embodiments. Furthermore, it will be readily apparent that the aspects and advantages of the invention may be realized by the means and combinations thereof set forth in the claims.

According to an aspect, there is provided a method of operating a metaverse system, the method including receiving a request for remote maintenance assistance of selected equipment from a worker via an augmented reality (AR) interface, in response to the request for remote maintenance assistance, synchronizing a view of an expert participating in a remote maintenance session in a virtual world with a digital twin of the equipment, and adjusting a virtual representation of a virtual object according to simulation of an operation of the equipment performed by the expert through the virtual object corresponding to the digital twin in the virtual world.

The adjusting of the virtual representation of the virtual object may include adjusting a size of the virtual object, or enlarging or modifying a shape of the virtual object.

The adjusting of the virtual representation of the virtual object may include adjusting the virtual representation of the virtual object by modifying virtual interface elements for the equipment.

The adjusting of the virtual representation of the virtual object may include adjusting at least one of size, color, shape, material, texture, transparency, animation behavior, physics simulation, sound, position, orientation, interaction, lighting, and sunlight response of the virtual object.

The synchronizing of the view of the expert with the digital twin of the equipment may include performing synchronization between an avatar of the worker, an avatar of the expert, and the digital twin.

The synchronizing of the view of the expert with the digital twin of the equipment may include applying a virtual task for the virtual object to the equipment, after confirmation of the worker or the expert is completed.

The method of operating the metaverse system may further include, in response to the expert completing a diagnosis, resetting the virtual object to its original state.

The method of operating the metaverse system may further include providing, in the virtual world, a maintenance situation in which the worker performs maintenance on the equipment for supervision by the expert, and providing corrective guidance of the expert according to the situation to the worker.

According to an aspect, there is provided a method of operating a metaverse system, the method including determining a structure of a physical object, based on product data related to the physical object, determining target properties that require modification to generate a virtual object, corresponding to the physical object, in a virtual world among properties included in the product data, based on the structure of the physical object, generating metadata related to the physical object according to a predetermined metadata structure, based on the target properties, and generating the virtual object in the virtual world, based on the metadata.

The generating of the virtual object may include acquiring target data related to a target physical object for which the virtual object is to be generated in the virtual world, and generating the virtual object corresponding to the target physical object by changing values of the target properties of the target data, based on the metadata.

The generating of the virtual object may include determining whether at least a portion of properties included in the target data correspond to properties included in the metadata, and in response to determining that at least a portion of the properties included in the target data correspond to properties included in the metadata, generating the virtual object.

The generating of the virtual object may include generating the virtual object by changing values of the target properties of the target data, or by determining values of the target properties as predetermined reference values, based on the metadata.

The target properties may include at least one of size, color, shape, material, texture, transparency, animation behavior, physics simulation, sound, position, orientation, interaction, lighting, and sunlight response of the physical object.

According to an aspect, there is provided a metaverse system including a processor, and memory storing instructions that, when executed by the processor, cause the metaverse system to receive a request for remote maintenance assistance of selected equipment from a worker via an AR interface, in response to the request for remote maintenance assistance, synchronize a view of an expert participating in a remote maintenance session in a virtual world with a digital twin of the equipment, and adjust a virtual representation of a virtual object according to simulation of an operation of the equipment performed by the expert through the virtual object corresponding to the digital twin in the virtual world.

The instructions, when executed by the processor, may cause the metaverse system to adjust a size of the virtual object, or enlarge or modify a shape of the virtual object.

The instructions, when executed by the processor, may cause the metaverse system to adjust the virtual representation of the virtual object by modifying virtual interface elements for the equipment.

The instructions, when executed by the processor, may cause the metaverse system to adjust at least one of size, color, shape, material, texture, transparency, animation behavior, physics simulation, sound, position, orientation, interaction, lighting, and sunlight response of the virtual object.

The instructions, when executed by the processor, may cause the metaverse system to perform synchronization between an avatar of the worker, an avatar of the expert, and the digital twin.

The instructions, when executed by the processor, may cause the metaverse system to apply a virtual task for the virtual object to the equipment, after confirmation of the worker or the expert is completed.

The instructions, when executed by the processor, may cause the metaverse system to, in response to the expert completing a diagnosis, reset the virtual object to its original state.

Additional aspects of embodiments will be set forth in part in the description which follows and, in part, will be apparent from the description, or may be learned by practice of the disclosure.

According to embodiments, a virtual service environment may be built more easily and quickly by adjusting a virtual representation of a virtual object corresponding to a physical object within a virtual world.

According to embodiments, a virtual object may be efficiently generated using product data related to a physical object, thereby reducing time and cost required to provide virtual services tailored to an intended purpose and use.

According to embodiments, product data related to the same physical object may be reused across diverse environments, and the generation of a virtual object corresponding to the physical object may be optimized to meet specific environmental requirements.

According to embodiments, size ratio mismatches, reduced visibility, or usability issues that may occur when a physical object is generated in the virtual world may be effectively improved.

According to embodiments, efficiency may be increased by eliminating unnecessary duplication of work in the process of converting product data through metadata and supporting customization for each environment and service.

According to embodiments, service-specific setting functions that may adjust virtual representations (e.g., size, color, shape, or detail) according to various service purposes (e.g., shopping, education, or engineering) may be provided, thereby enabling rapid generation of a virtual object suited to service requirements and providing optimized user experiences.

According to embodiments, default, environment-specific, or service-specific settings may be systematically managed through metadata independent of product data, simplifying data modification and updates, and facilitating expansion to new environments or services.

According to embodiments, time and cost required to generate a virtual object corresponding to a physical object may be reduced by making a single piece of metadata related to the physical object available in various service environments.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating an operation of adjusting a virtual representation according to an embodiment;

FIG. 2 is a diagram illustrating a metaverse system according to an embodiment;

FIG. 3 is a diagram illustrating metadata according to an embodiment;

FIG. 4 is a diagram illustrating a process of generating metadata according to an embodiment;

FIG. 5 is a diagram illustrating a process of generating a virtual object according to an embodiment;

FIG. 6 is a diagram illustrating a process of registering a virtual object according to an embodiment;

FIG. 7 is a diagram illustrating remote maintenance assistance through a digital twin according to an embodiment;

FIG. 8 is a diagram illustrating a process of remote maintenance assistance according to an embodiment;

FIGS. 9 to 14C are diagrams illustrating an example of a structure of metadata according to an embodiment;

FIG. 15 is a flowchart illustrating a method of operating a metaverse system for remote maintenance assistance, according to an embodiment;

FIG. 16 is a flowchart illustrating a method of operating a metaverse system for generating a virtual object through metadata, according to an embodiment; and

FIG. 17 is a block diagram of a metaverse system according to an embodiment.

### DETAILED DESCRIPTION

The following structural or functional description is provided as an example only and various alterations and modifications may be made to the embodiments. Accordingly, the embodiments are not construed as limited to the disclosure and should be understood to include all changes, equivalents, and replacements within the idea and the technical scope of the disclosure.

As used herein, “A or B”, “at least one of A and B”, “at least one of A or B”, “A, B or C”, “at least one of A, B and C”, “at least one of A, B, or C”, and “one or a combination of at least two of A, B, and C,” each of which may include any one of the items listed together in the corresponding one of the phrases, or all possible combinations thereof. Although terms of “first” or “second” are used to explain various components, the components are not limited to the terms. These terms should be used only to distinguish one component from another component. For example, a “first” component may be referred to as a “second” component, or similarly, the “second” component may be referred to as the “first” component.

It will be understood that when a component is referred to as being “connected to” or “coupled” to another component, the component may be directly connected or coupled to the other component or intervening components may be present.

As used herein, the singular forms “a,” “an,” and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, should be construed to have meanings matching with contextual meanings in the relevant art and the present disclosure, and are not to be construed as an ideal or excessively formal meaning unless otherwise defined herein.

Hereinafter, embodiments will be described in detail with reference to the accompanying drawings. When describing the embodiments with reference to the accompanying drawings, like reference numerals refer to like components and a repeated description related thereto will be omitted.

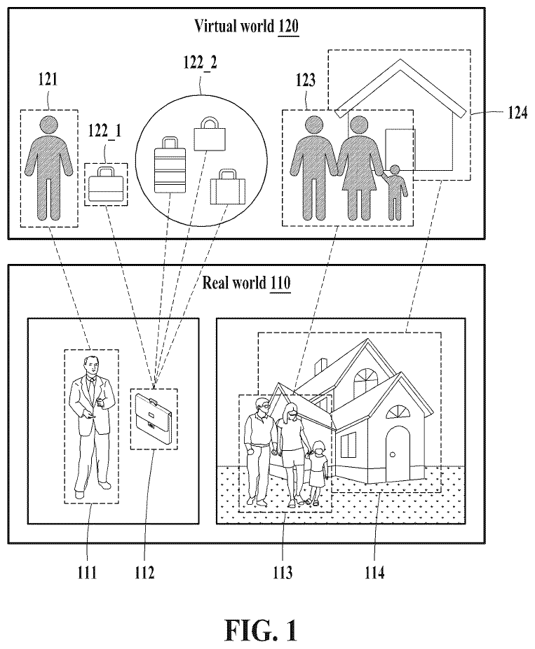

FIG. 1 is a diagram illustrating an operation of adjusting a virtual representation according to an embodiment.

Referring to FIG. 1, a metaverse system may generate virtual objects corresponding to physical objects in a real world 110 in a virtual world 120. For example, the metaverse system may generate digital twin objects as virtual objects in the virtual world 120 by generating digital twins corresponding to physical objects in the real world 110. In the example of FIG. 1, avatar objects 121 and 123 and a house object 124 generated in the virtual world 120 respectively corresponding to people 111 and 113 and a house 114 in the real world 110 are illustrated. Additionally, bag objects 122_1 and 122_2 generated in the virtual world 120 corresponding to a bag 112 in the real world 110 are illustrated.

A physical object may be an object that exists in the real world 110. For example, a physical object may be an object that has a distinct existence in a physical world, either tangible (e.g., a machine or device) or intangible (e.g., a process or traffic flow). In the present disclosure, for ease of description, a physical object may also be referred to as an actual object or a real object.

A virtual object may be a computer-generated entity designated for the virtual world 120. A virtual object may be a replica of a physical object and may become a digital twin.

The real world 110 may be a spatial organization of a plurality of physical objects. In the present disclosure, for ease of description, the real world 110 may also be referred to as the physical world or the actual world.

The virtual world 120 may be a spatial configuration of a plurality of virtual objects. The virtual world 120 may include global behavior. Within the virtual world 120, users may generate avatars to represent themselves and interact with virtual objects and other avatars in various ways.

A metaverse may be a collective virtual environment where the physical world merges with the virtual world 120, allowing users to interact with shared digital spaces, objects, and services. The metaverse may be virtual, augmented, or representative of the actual world, or connected to the actual world. In other words, the metaverse may represent the virtual world 120 that includes a digital twin-based virtual service environment such as virtual reality (VR), augmented reality (AR), and mixed reality (MR). The metaverse may be an integrated ecosystem of virtual worlds 120 that provides users with immersive experiences, and may modify existing values and generate new values from economic, environmental, social, and cultural perspectives. The metaverse may include the virtual worlds 120 implemented to enable human activities in the real world 110.

A digital twin may be a digital representation of an object of interest. For example, the digital twin may be a digital representation of physical objects in the real world 110 implemented in the virtual world 120 or metaverse. The digital twin may require different functions (e.g., synchronization, real-time support, and the like), depending on the field of application. The digital twin may link the virtual world 120 to the real world 110, allowing users to expand their experiences beyond limitations of a virtual environment. The digital twin may be a digital representation of physical objects and may be part of the virtual world 120. For example, an avatar representing a user may be a digital twin within the virtual world 120. The digital twin may be a performing object between two worlds, for linking the virtual world 120 to the real world 110. For example, the digital twin of a user may reflect a facial expression captured by user equipment, as an avatar.

The metaverse system may implement a metaverse service by designing and providing a customized virtual world based on a user preference. In an embodiment, the metaverse system may be implemented as an electronic device including a processor and memory. For example, the metaverse system may include various computing devices, such as a mobile phone, a smartphone, a tablet personal computer (PC), an e-book device, a laptop, a PC, a desktop, a workstation, or a server, various wearable devices, such as a smartwatch, smart glasses, a head-mounted display (HMD), or smart clothing, various home appliances, such as a smart speaker, a smart television (TV), or a smart refrigerator, and other devices, such as a smart vehicle, a smart kiosk, an Internet of Things (IoT) device, a walking assist device (WAD), a drone, or a robot, but examples are not limited thereto.

In a virtual service environment, conversion or adjustment of data related to a physical object may be required to generate a virtual object corresponding to the physical object. In the present disclosure, for ease of description, data related to a physical object may also be referred to as product data. For example, adjustment of product data may be required depending on a purpose of a virtual service. When generating a virtual object using product data, issues may arise regarding the shape size, visual consistency, or usability of the physical object, so size scaling (e.g., enlargement and reduction), shape modification, and contextual adaptability in the virtual service environment may be required.

According to an embodiment, the metaverse system may adjust a virtual representation of a virtual object in the virtual world 120. Additionally, the metaverse system may determine target properties that require modification among properties included in data related to a physical object in the real world, and may generate a virtual object corresponding to the physical object by modifying values of the target properties. For example, the metaverse system may generate a virtual object corresponding to the physical object by modifying properties (e.g., size, shape, and geometry) of the physical object. The metaverse system may provide size adjustment, property modification, and contextual adaptability across diverse virtual environments through a metadata-based framework, enabling effective integration of identical product data across diverse virtual service environments.

In an embodiment, the metaverse system may adjust a virtual representation of a virtual object based on the usability of a user. Since the usage environments and characteristics of the real world 110 and the virtual world 120 are different, a virtual object generated in response to a physical object may be inconvenient for a user to use in a virtual service environment. In the example of FIG. 1, a door handle of the house 114 may be of an appropriate size and shape for the person 113 to open and close the door in the real world 110. However, a door handle of the house object 124 generated in the virtual service environment may be inconvenient for the avatar object 123 of the user to use, or for the user to use through a user interface (UI). For example, in the virtual world 120, inconveniences may occur in terms of visibility, size, color, or structure. The metaverse system may increase usability by changing a color, increasing the size, or modifying the shape of the door handle of the house object 124 so that a user may easily select and open and close the door handle of the house object 124 simply in the virtual world 120. In addition, since an operation target, such as an operation button or switch handle of equipment in factory equipment, may be difficult to recognize or operate in the virtual world 120, the metaverse system may change a color of the operation target, increase the size of the operation target, or modify the shape of the operation target to increase usability.

In an embodiment, the metaverse system may adjust a virtual representation of a virtual object based on the visibility of a user. For example, people may desire to see enlarged sizes of digital twin objects for better visibility and recognition. In the example of FIG. 1, the bag 112 in the real world 110 may have a particular size ratio to the person 111. In the virtual world 120, the bag object 122_1 and the avatar object 121 may be generated according to the corresponding size ratio. On the other hand, within the metaverse, the bag object 122_2 may be intentionally enlarged to avoid difficulty in recognizing small objects. Additionally, the metaverse system may increase visibility of a user by changing a color of the bag object 122_2, increasing the size of the bag object 122_2, or modifying the shape of the bag object 122_2. In the context of a metaverse factory, size adjustment issues may be important. While precise dimensional specifications are important for design and manufacturing purposes, a maintenance worker interacting with digital twin objects of equipment may have difficulty recognizing small components represented by precise physical dimensions. Metaverse services may be required to consider a balanced approach to addressing size adjustment issues. For engineering applications, metaverse services may be required to maintain accurate size adjustments while providing appropriate visual adjustments, such as enlarging small components for better perception and usability in maintenance and operational scenarios.

In an embodiment, the metaverse system may adjust a virtual representation of a virtual object based on service-specific requirements. For example, the metaverse system may display a virtual object enlarged for a better user experience in a shopping scenario, and in an engineering scenario, equipment may be represented as an actual size for precision.

In an embodiment, the metaverse system may adjust a virtual representation of a virtual object by modifying virtual interface elements of the virtual object based on a predefined profile for the virtual object according to a purpose and requirements of a service. Additionally, the metaverse system may generate a virtual object corresponding to a physical object and then dynamically modify the virtual interface elements of the virtual object to adjust the virtual representation of the virtual object.

Metaverse services may provide users with better visibility, recognition, and interaction by adjusting virtual representations of digital twin objects based on predefined metadata profiles within the virtual world 120. Modifications of the virtual representation may include, but are not limited to, modifications to size, color, shape, material and texture, transparency, animation behavior, physics simulation, sound, position/orientation, interaction, lighting and sunlight response, and the like.

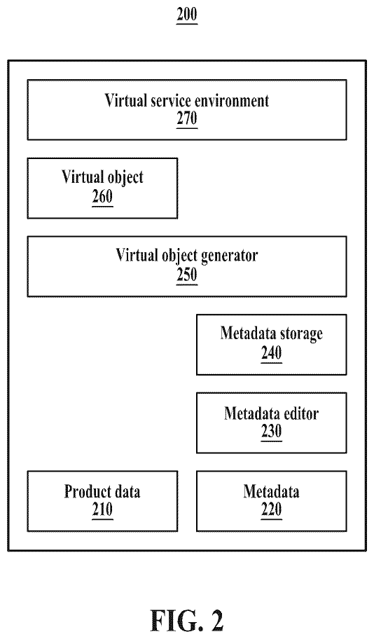

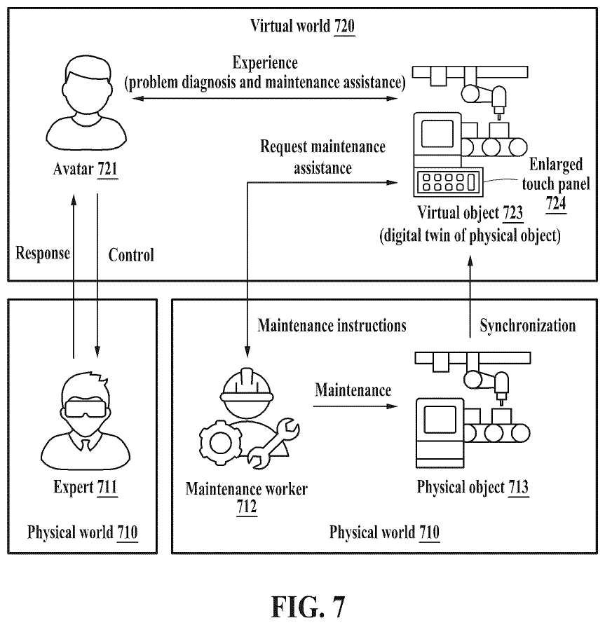

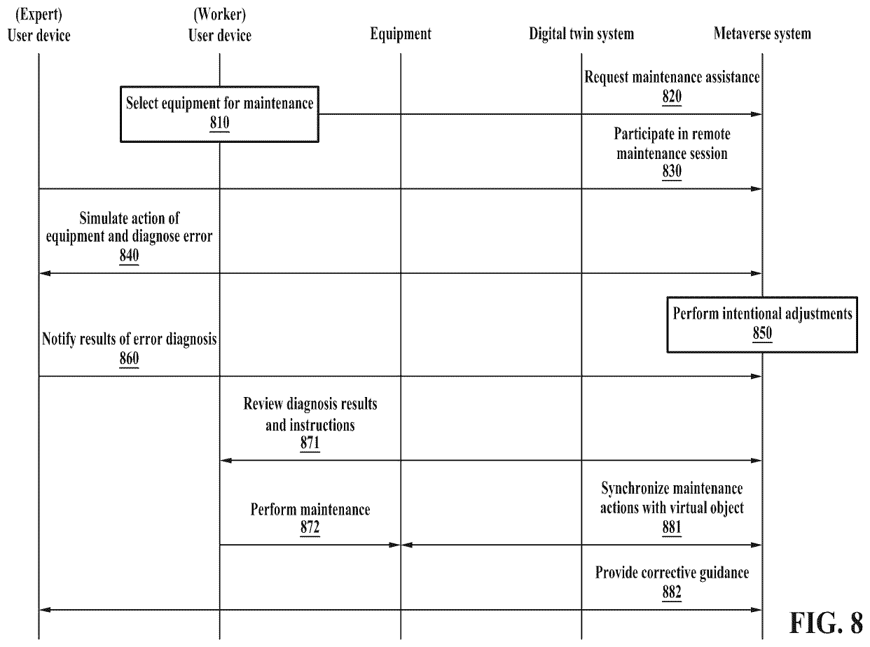

The process of adjusting the virtual representation of a virtual object by changing the values of the properties of the product data related to a physical object is described in detail with reference to FIGS. 2 to 6 below, and the process of adjusting the virtual representation of a virtual object in a scenario for remote maintenance assistance of equipment is described in detail with reference to FIGS. 7 and 8 below.

FIG. 2 is a diagram illustrating a metaverse system according to an embodiment. Referring to FIG. 2, a metaverse system 200 may include a metadata editor 230, a metadata storage 240, and a virtual object generator 250. The metaverse system 200 may generate a virtual object 260, corresponding to a physical object, in a virtual service environment 270, based on product data 210 and metadata 220, and may adjust a virtual representation of the virtual object 260. In FIG. 2, the metadata editor 230, the metadata storage 240, and the virtual object generator 250 are shown as separate modules or hardware devices. However, embodiments are not limited thereto, and they may also be implemented as software by a processor.

The product data 210 may be generated for the purpose of manufacturing or producing a physical object in the real world. For example, the product data 210 may be implemented in the form of a three-dimensional (3D) computer-aided-design (CAD) data file (e.g., Standard for the Exchange of Product Model Data (STEP), Initial Graphics Exchange Specification (IGES), and the like), but embodiments are not limited thereto. In an embodiment, the metaverse system 200 may easily and quickly generate the virtual object 260, corresponding to a physical object, in the virtual world, based on the product data 210 of the physical object existing in the real world, and may adjust a virtual representation of the virtual object 260 according to a purpose or requirements of a virtual service.

The metadata 220 may be data for adjusting properties such as size, shape, or color, according to the virtual service environment 270 and service purpose, when the virtual object 260 is generated based on the product data 210. For example, the metadata 220 may be implemented in a structured format such as JavaScript Object Notation (JSON) or Extensible Markup Language (XML), but embodiments are not limited thereto.

The metadata editor 230 may generate, edit, or manage the metadata 220. In an embodiment, the metadata editor 230 may establish a connection relationship between the product data 210 and the metadata 220, and may set configuration information of the metadata 220.

The metadata storage 240 may store the metadata 220 for generating the virtual object 260 based on the product data 210. The metadata storage 240 may store the metadata 220 together with the product data 210, but embodiments are not limited thereto. For example, the metadata storage 240 may store the metadata 220 in a cloud provided by a server connected to a metaverse service.

The virtual object generator 250 may generate the virtual object 260 based on the product data 210 and the metadata 220. The virtual object generator 250 may determine target properties that require modification to generate a virtual object corresponding to a physical object, and may adjust a virtual representation of the virtual object by adjusting values of the target properties. In an embodiment, the virtual object generator 250 may adjust a virtual representation of the virtual object 260 by modifying virtual interface elements of the virtual object 260 based on a predefined profile for the virtual object 260 according to the purpose and requirements of the service. In addition, the virtual object generator 250 may generate the virtual object 260 corresponding to the physical object and then dynamically modify the virtual interface elements of the virtual object 260 to adjust the virtual representation of the virtual object 260.

The virtual object 260 may be an object generated in the virtual world by the virtual object generator 250. The virtual object 260 may be generated by adjusting properties of the virtual object 260 from the product data 210 and the metadata 220 according to a service purpose and use. In an embodiment, a virtual object may be implemented in the form of a data file corresponding to a physical object.

The virtual service environment 270 may be various virtual service platforms such as AR, VR, MR, metaverse, or digital twin provided by the metaverse system 200. In the virtual service environment 270, the metaverse system 200 may provide a virtual service to a user using the generated virtual object 260.

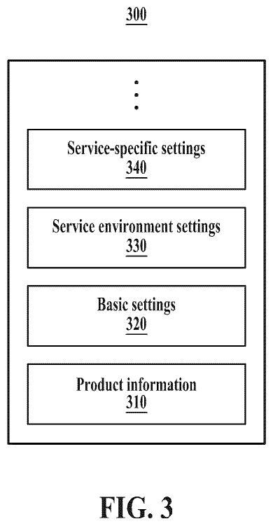

FIG. 3 is a diagram illustrating metadata according to an embodiment.

Referring to FIG. 3, metadata 300 may include product information 310, basic settings 320, service environment settings 330, and service-specific settings 340 related to a corresponding physical object. Components included in the metadata 300 may be expanded according to the purpose of a virtual service.

The product information 310 may include product data related to a physical object in the real world. For example, the product information 310 may include information for uniquely identifying a physical object, such as an identification (ID), version, or product name of product data. In an embodiment, the product information 310 may define relationships between parts, subassemblies, and final products through hierarchical configuration information of a physical object based on a bill of materials (BOM).

The basic settings 320 may be modification properties that may be modified and are commonly applied to virtual objects generated based on product data. For example, the basic settings 320 may include common modification properties such as size scaling ratio, color, level of detail (LOD), or rendering quality, but embodiments are not limited thereto.

The service environment settings 330 may be modification properties optimized for a virtual service environment. For example, the service environment settings 330 may include, but are not limited to, modification properties such as optimal size in a VR environment, scaling in a user device-based mobile environment, and LOD in an AR environment.

The service-specific settings 340 may be properties according to virtual services such as shopping, education, or games.

According to an embodiment, the metadata 300 may further include additional components of property information separated from the product information 310, the basic settings 320, the service environment settings 330, and the service-specific settings 340. For example, the metadata 300 may include size scaling ratio information separated as a component. Additionally, the metadata 300 may include additional components that express information when there is an interaction dependency with other virtual objects. For example, the metadata 300 may also include maintenance information for tracking a generation date, management entity, or change history of the metadata 300 itself as additional components.

The metadata 300 may be expressed in various ways. For example, the metadata 300 may be implemented in a sequential listing approach, a hierarchical structure approach, a condition and rule-based approach, or a plug-in structure approach, but embodiments are not limited thereto.

The sequential listing approach may be a scheme of listing components of the metadata 300 sequentially and defining each component independently. The sequential listing approach may simplify structure, making it easier for a user to understand the structure of the metadata 300, and may facilitate data management. For example, the metadata 300 may be expressed as follows according to the sequential listing approach.
Product information
Basic settings
Service environment settings
Service-specific settings

The hierarchical structure approach may be a scheme of organizing the components of the metadata 300 hierarchically, defining that upper components include lower components. The hierarchical structure approach may more clearly define relationships between data and make it easier to manage reusability and priorities of settings. For example, the metadata 300 may be expressed as follows according to the hierarchical structure approach.
Upper: Product information
Middle: Basic settings
Lower: Service environment settings-service-specific settings

The condition and rule-based approach may be a scheme of structuring the components of the metadata 300 based on conditions and rules. The condition and rule-based approach may increase flexibility and extensibility of the metadata 300 by allowing settings to be applied dynamically according to conditions. For example, the metadata 300 may be expressed as follows according to the condition and rule-based approach.
Condition: Service environment or service conditions for the product
Action: Settings for object adjustments to be applied when a condition is met

The plug-in structure approach may be a scheme in which the components of the metadata 300 are designed as plug-ins so that components may be added or removed as needed. The plug-in structure approach may allow each plug-in to operate independently, thereby increasing extensibility of the metadata 300 and allowing functions or settings to be processed independently. For example, the metadata 300 may be expressed as follows according to the plug-in structure approach.
Plug-ins: Product information plug-in, basic settings plug-in, service environment settings plug-in, service-specific plug-in, and the like.

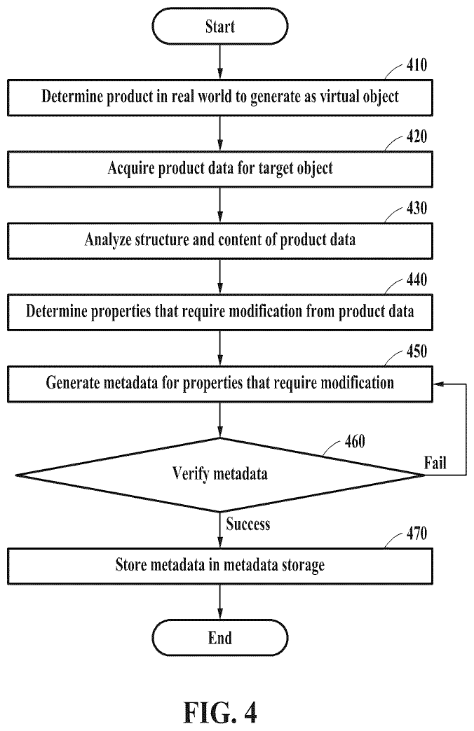

FIG. 4 is a diagram illustrating a process of generating metadata according to an embodiment.

Referring to FIG. 4, a metaverse system may determine target properties to be modified according to a service scenario, purpose, or use of a virtual world, based on product data, to generate metadata.

In the following embodiments, operations may be performed sequentially but not necessarily. For example, the order of the operations may change, and at least two of the operations may be performed in parallel. Operations 410 to 470 may be performed by at least one component (e.g., a processor, etc.) of the metaverse system.

In operation 410, the metaverse system may determine a product in the real world to generate as a virtual object. In the present disclosure, for ease of description, the determined product may also be referred to as a target object. The metaverse system may determine a physical object to generate as a virtual object based on a user's selection.

In operation 420, the metaverse system may acquire product data for the target object. Here, a file format of the product data may be of various types, such as STEP or IGES, but embodiments are not limited thereto.

In operation 430, the metaverse system may analyze a structure and content of the product data for the target object. For example, the metaverse system may input the product data to a metadata editor.

In operation 440, the metaverse system may determine properties that require modification from the product data according to a virtual service environment. The metaverse system may determine the properties that require modification based on the user's selection. The properties that require modification may include, but are not limited to, size, scale, color, or shape.

In operation 450, the metaverse system may generate metadata by modifying values of the properties that require modification. The metaverse system may generate the metadata according to a structure of the metadata, based on modification result values of the properties that require modification. For example, the metaverse system may generate the metadata through a metadata editor.

In operation 460, the metaverse system may verify the generated metadata. In an embodiment, the metaverse system may verify, through a verification module included in the metadata editor, at least one of whether metadata is consistent with product data, whether there are conflicts between properties, and whether required setting values in the virtual service environment are correctly included. For example, the metaverse system may verify whether a scaling ratio and color information included in the metadata conflict with the properties of the product data. Additionally, the metaverse system may verify whether some properties of the product data are missing from the metadata. When the metaverse system fails verification, the metaverse system may correct an error by performing operation 450 again.

In operation 470, when verification of the metadata is successful, the metaverse system may store the generated metadata in a metadata storage. In an embodiment, the metadata storage may be implemented as a storage or file system of a cloud service. However, the embodiment is not limited thereto, and the metadata storage may be implemented differently depending on the development environment and operating environment.

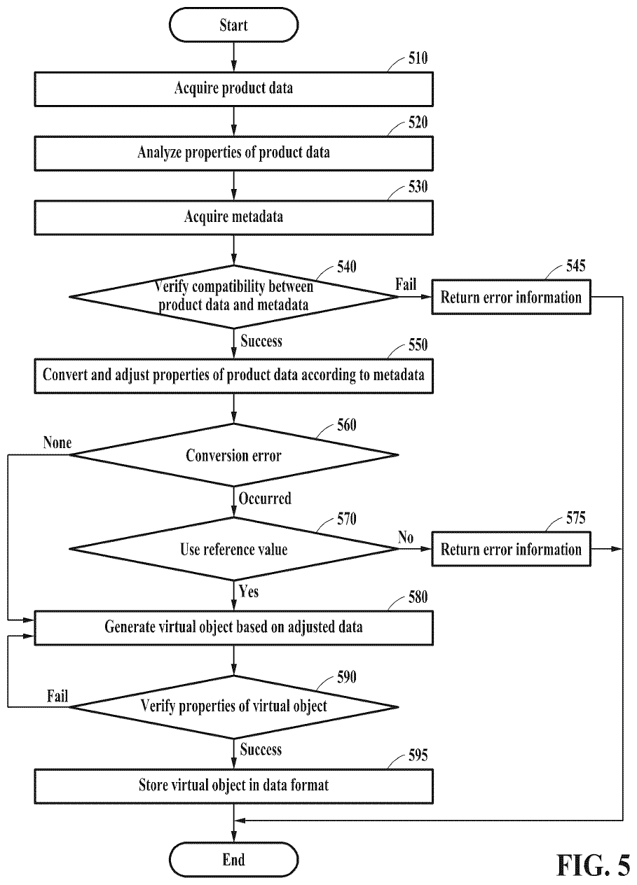

FIG. 5 is a diagram illustrating a process of generating a virtual object according to an embodiment.

Referring to FIG. 5, a metaverse system may generate a virtual object based on product data and metadata. For example, the metaverse system may generate a virtual object according to instructions of a developer or operator building a virtual service environment.

In the following embodiments, operations may be performed sequentially but not necessarily. For example, the order of the operations may change, and at least two of the operations may be performed in parallel. Operations 510 to 595 may be performed by at least one component (e.g., a processor, etc.) of the metaverse system.

In operation 510, the metaverse system may acquire product data of a physical object to be generated as a virtual object. For example, the metaverse system may receive product data from a user in the form of STEP files or CAD files through a virtual object generator.

In operation 520, the metaverse system may analyze the product data to analyze properties of the physical object.

In operation 530, the metaverse system may acquire metadata for the physical object. For example, the metaverse system may acquire metadata stored in a metadata storage through a virtual object generator.

In operation 540, the metaverse system may analyze the metadata to analyze compatibility between the product data and metadata. In an embodiment, the metaverse system may analyze the metadata to verify product information, and verify compatibility between the product data and metadata by analyzing basic settings, service environment settings, and service-specific settings. Through this process, the metaverse system may determine properties to modify among the properties included in the metadata.

In operation 545, when verification of the compatibility between the product data and metadata fails, the metaverse system may return compatibility-related error information. For example, the metaverse system may return compatibility-related error information when a product ID or property information in the metadata is different from the product data.

In operation 550, when verification of the compatibility between the product data and metadata is successful, the metaverse system may convert and adjust properties of the product data according to the metadata. For example, the metaverse system may generate a physical object as a virtual object by converting and adjusting properties of the product data as set in the metadata, through a data conversion module included in the virtual object generator.

In operation 560, the metaverse system may determine whether an error occurs in the property conversion and adjustment of the product data. The metaverse system may determine that an error has occurred when a property of the product data is not converted or is missing from the metadata settings.

In operation 570, the metaverse system may determine a predetermined reference value for the property in which an error has occurred, when an error occurs. In the present disclosure, for ease of description, the reference value may also be referred to as a default value.

In operation 575, the metaverse system may return corresponding error information when a reference value is not available for the property in which an error has occurred.

In operation 580, the metaverse system may generate a virtual object corresponding to the product data, based on the converted and adjusted property values or reference values.

In operation 590, the metaverse system may verify properties of the virtual object. For example, the metaverse system may verify whether the virtual object is generated as intended by comparing properties, such as size, color, or shape, of the virtual object with the metadata settings, based on the user's confirmation. The metaverse system may provide the user with information that allows the user to visually confirm the properties of the virtual object for verification.

In operation 595, when verification of the properties of the virtual object is successful, the metaverse system may store the generated virtual object in a data format such as Filmbox (FBX), Object (OBJ), or Graphics Library Transmission Format (GLTF) depending on the virtual service environment. For example, the metaverse system may store the virtual object in any of a set of data formats, depending on the user's selection.

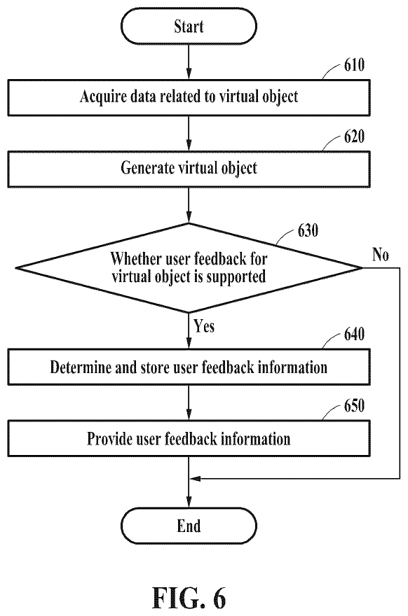

FIG. 6 is a diagram illustrating a process of registering a virtual object according to an embodiment.

Referring to FIG. 6, a metaverse system may register a virtual object in a virtual service environment platform. For example, in a virtual service environment platform, the metaverse system may register a virtual object generated by a developer or operator building a virtual service environment.

In the following embodiments, operations may be performed sequentially but not necessarily. For example, the order of the operations may change, and at least two of the operations may be performed in parallel. Operations 610 to 650 may be performed by at least one component (e.g., a processor, etc.) of the metaverse system.

In operation 610, the metaverse system may acquire data related to a virtual object. For example, the metaverse system may receive files of the virtual object from a user through a virtual service environment platform.

In operation 620, the metaverse system may generate the virtual object using the data related to the virtual object through the virtual service environment platform.

In operation 630, the metaverse system may verify whether user feedback for the virtual object is supported in the virtual service environment platform. The virtual service environment platform may operate a channel to receive user feedback regarding a final service for the virtual object. The metaverse system may not register the virtual object in the virtual service environment platform when the virtual service environment platform does not support user feedback regarding the virtual object.

In operation 640, the metaverse system may determine and store user feedback information when user feedback for the virtual object is supported in the virtual service environment platform. For example, a user of a final service may evaluate the virtual object generated in a virtual service environment and input any necessary adjustments to the generated virtual object. The metaverse system may determine and store user feedback information from the user feedback through the virtual service environment platform.

In operation 650, the metaverse system may provide the user feedback information of a metadata editor to the user through the virtual service environment platform. For example, the metaverse system may display and manage properties that require modification in the virtual object, based on the user feedback information.

FIG. 7 is a diagram illustrating remote maintenance assistance through a digital twin according to an embodiment.

Referring to FIG. 7, a metaverse system may support remote maintenance of a physical object 713 through a virtual object 723 corresponding to a digital twin of the physical object 713.

The metaverse system may generate an avatar 721, corresponding to an expert 711 in a physical world 710, in a virtual world 720. The avatar 721 may correspond to a digital twin of the expert 711 in the virtual world 720. The expert 711 may control the avatar 721 through an AR interface of the metaverse system and receive a response from the avatar 721 according to the control. The expert 711 may use an AR interface (or VR interface) through a wearable device (e.g., smart glasses, an HMD, or AR glasses), but embodiments are not limited thereto.

The metaverse system may generate the virtual object 723 in the virtual world 720 corresponding to the physical object 713 (e.g., equipment) in the physical world 710 selected for remote maintenance. In the present disclosure, the physical object 713 may be, for example, equipment used in an industrial field, but embodiments are not limited thereto. The virtual object 723 may correspond to a digital twin of the physical object 713 in the virtual world 720. The metaverse system may synchronize the virtual object 723 with the physical object 713 through a digital twin system. For example, the metaverse system may synchronize the virtual object 723 with an action, state, and data of the physical object 713. The metaverse system may adjust a virtual representation of the virtual object 723. The virtual representation may be included as an adjustable property of a corresponding digital twin model. Types of the adjustable properties may vary depending on the characteristics of a physical object, and may include, but are not limited to, size, color, shape, material and texture, transparency, animation behavior, physics simulation, sound, position and orientation, interaction, lighting or sunlight response. For example, the metaverse system may enlarge a touch panel of the physical object 713 at the request of the expert 711 to generate an enlarged touch panel 724 in the virtual world 720.

In an embodiment, the expert 711 that is remotely located may collaborate with a maintenance worker 712 located next to industrial equipment to perform remote maintenance assistance. The collaboration may be performed through the virtual world 720 to support effective and efficient maintenance operations. The virtual object 723 representing synchronized equipment through a digital twin system may enable the expert 711 to guide the maintenance worker 712 through virtual interactions.

Assumptions related to the scenario in FIG. 7 may be as follows.
There may be a metaverse system that maintains the virtual world 720 for multi-user collaboration through avatars.
There may be a digital twin system that supports real-time synchronization between physical industrial equipment and virtual representations within the virtual world 720 based on metaverse.
The maintenance worker 712 on site may wear AR glasses to interact with the virtual world 720 and select the physical object 713 to be maintained.
The maintenance worker 712 may be located next to the physical object 713 and may perform manual maintenance work directly.
The expert 711 located remotely may safely and remotely access the virtual world 720 through a VR interface (or AR interface) and manipulate the digital twin of the equipment.
The metaverse system may adjust virtual interface elements (e.g., equipment control panels) for better visibility or interaction. For example, the metaverse system may enlarge the touch panel and adjust a shape pattern in the virtual space.
Policies that manage synchronization may determine whether virtual actions by the expert 711 or the maintenance worker 712 are applied in real time to the physical equipment or remain virtual for safety reasons until verified. For example, the metaverse system may determine whether virtual actions are applied to the physical equipment in real time or remain virtual for safety until verified, based on policies that manage synchronization through the digital twin system.

The process of performing remote maintenance assistance for the physical object 713 through a digital twin is described in detail with reference to FIG. 8 below.

FIG. 8 is a diagram illustrating a process of remote maintenance assistance according to an embodiment.

Referring to FIG. 8, an example of operations performed by a user device of an expert, a user device of a worker, a digital twin system, and a metaverse system to support remote maintenance assistance of equipment is illustrated.

In the following embodiments, operations may be performed sequentially but not necessarily. For example, the order of the operations may change, and at least two of the operations may be performed in parallel. Operations 810 to 882 may be performed by at least one component (e.g., a processor, etc.) of a user device of an expert, a user device of a worker, a digital twin system, or a metaverse system. In the present disclosure, for ease of description, the operations performed by the user device of the expert and the user device of the worker may also be described as operations performed by the expert and the worker, respectively.

In an embodiment, when a maintenance worker on site encounters complex industrial equipment that requires expert guidance, the maintenance worker may initiate a collaborative maintenance session in a metaverse-based virtual world. In the present disclosure, for ease of description, the collaborative maintenance session may also be referred to as a remote maintenance session. A remote manager may connect to a corresponding virtual space and establish synchronization between an avatar of the remote manager, an avatar (or AR view) of the maintenance worker, and a digital twin of the equipment. Within this shared virtual world, the expert may remotely demonstrate required maintenance tasks, and the maintenance worker may perform those tasks using a virtual interface of the equipment, including interacting with complex control elements such as touch panels. The metaverse system may adjust the virtual interface (e.g., enlarging touch panel controls on equipment) during the collaborative maintenance session, providing clearer demonstrations and more accurate interactions for both the expert and the maintenance worker on site.

The metaverse system may support the use and manipulation of adjustment metadata to dynamically render a digital twin and intentionally modify geometric and structural models.

In operation 810, the maintenance worker may select a particular piece of equipment for maintenance through AR glasses.

In operation 820, the maintenance worker may select a task related to the selected equipment through an AR interface to request remote maintenance assistance from a metaverse system.

In operation 830, when a remote expert receives a remote maintenance assistance request, the remote expert may connect to the metaverse system and participate in a remote maintenance session in a virtual world. The metaverse system may invite the expert to participate in a remote maintenance session based on a request from the expert to participate in the remote maintenance session of a user device. The metaverse system may synchronize a view of the expert with a digital twin of the equipment, allowing the expert to remotely check the equipment for maintenance.

In operation 840, the expert may simulate an action of the equipment and diagnose errors using a virtual object of the equipment.

In operation 850, the metaverse system may perform intentional adjustments to a virtual representation of the virtual object of the equipment at the request of the expert. For example, the expert may adjust the size or shape of the virtual object while diagnosing an error, making it easier to access and easier to interact with the virtual object. The metaverse system may adjust the size or shape of the virtual object under control of the expert. Additionally, the metaverse system may adjust at least one of the size, color, shape, material, texture, transparency, animation behavior, physics simulation, sound, position, orientation, interaction, lighting, and sunlight response of the virtual object under control of the expert, but embodiments are not limited thereto. Adjustment of the virtual representation of the virtual object may help the expert to control small components, such as touch panels or other small interface elements, based on a predefined metadata profile within the virtual world.

In operation 860, the expert may notify results of the error diagnosis to the metaverse system. After completing the diagnosis, the expert may inform the maintenance worker of the results and reset the virtual object to its original state.

In operation 871, the maintenance worker and the metaverse system may review the diagnosis results and instructions.

In operation 872, the maintenance worker may start maintenance work based on the diagnosis and instructions of the expert.

In operation 881, the metaverse system may synchronize maintenance actions with the virtual object. For example, the metaverse system may synchronize maintenance actions of the maintenance worker with the virtual object through a digital twin system.

In operation 882, the expert may continuously monitor the situation through the metaverse system while maintenance is in progress. The expert may provide corrective guidance through the AR interface when a problem occurs or incorrect actions are detected. The corrective guidance may be determined by the expert based on the circumstances under which maintenance is performed. For example, the corrective guidance may be revised guidance on the diagnosis and instructions of the expert.

In an embodiment, maintenance actions may be synchronized in real time with the virtual object, ensuring consistency between the actual equipment and a corresponding virtual representation of the actual equipment.

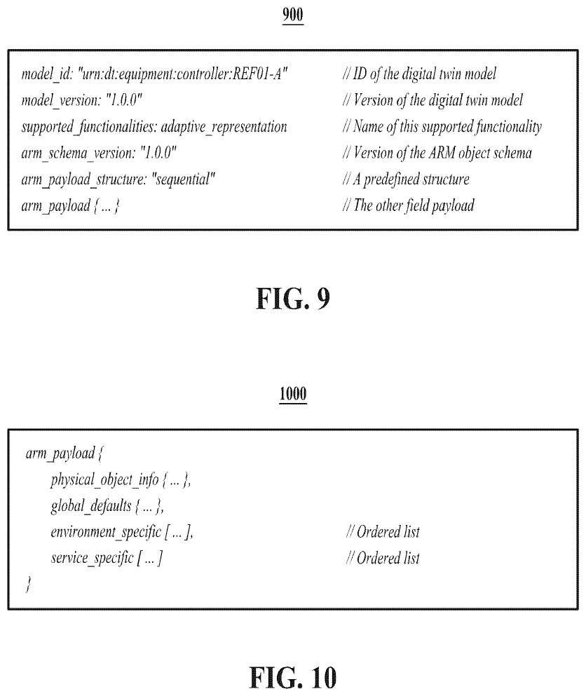

FIGS. 9 to 14C are diagrams illustrating an example of a structure of metadata according to an embodiment.

Metadata may include adaptive representation metadata (ARM). ARM may define deterministic adaptation directives based on properties of a digital twin model. Through the ARM, metaverse-side functions may retrieve, select, and consistently apply appropriate digital twin models across various virtual service contexts. The ARM may include fields for “control” for control and “payload” for payload.

Referring to FIG. 9, a “control” field 900 related to control of the ARM is illustrated as an example. The “control” field 900 illustrated in FIG. 9 is only an example for description, and embodiments are not limited thereto.

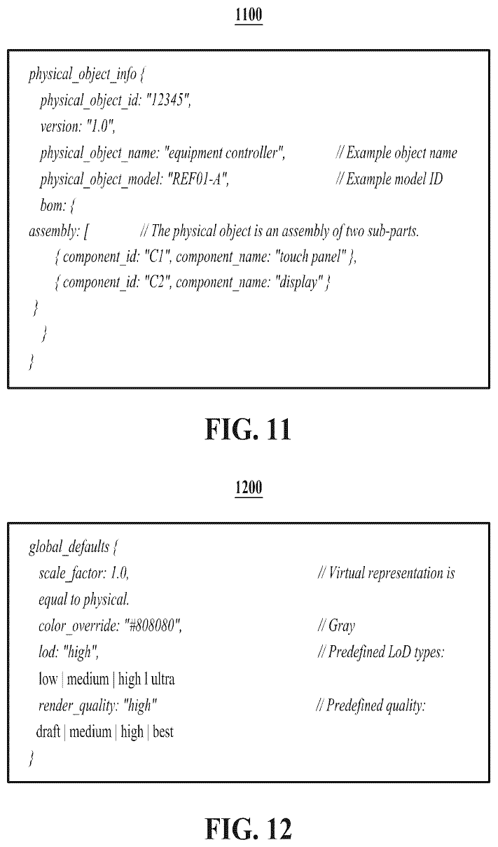

Referring to FIG. 10, a “payload” field 1000 related to a payload of the ARM is illustrated as an example. The “payload” field 1000 illustrated in FIG. 10 is only an example for description, and embodiments are not limited thereto.

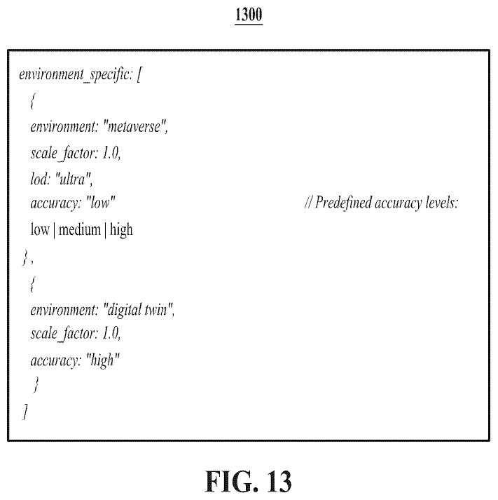

Referring to FIG. 11, a block 1100 of “physical_object_info {. . . }” defined in the “payload” field 1000 of FIG. 10 is illustrated as an example. The block 1100 illustrated in FIG. 11 is only an example for description, and embodiments are not limited thereto.

“physical_object_info {. . . }” may uniquely identify a physical object and may reference structures (e.g., assemblies or parts of the physical object) for component-level targeting. Here, the example illustrated in FIG. 11 may correspond to a case where the physical object is a manufactured product.

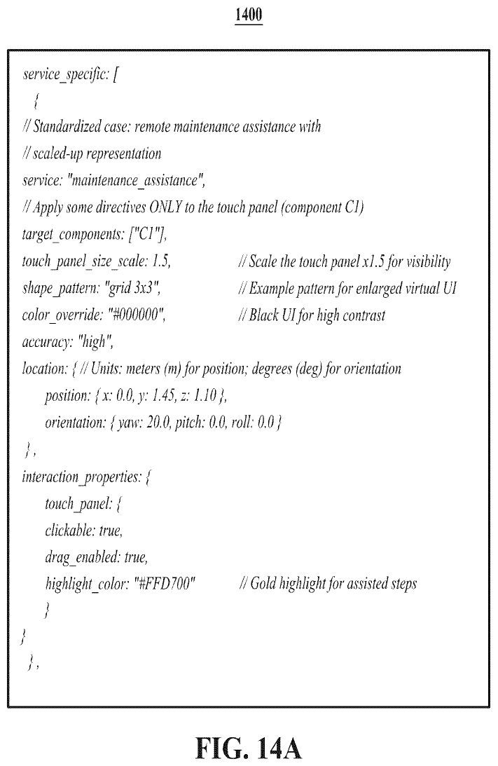

Referring to FIG. 12, a parameter 1200 of “global_defaults {. . . }” defined in the “payload” field 1000 of FIG. 10 is illustrated as an example. The parameter 1200 shown in FIG. 12 is only an example for description, and embodiments are not limited thereto.

“global_defaults {. . . }” may define baseline adjustments (e.g., “scale_factor”, “color_override”, “lod”, and the like) that apply to all contexts unless overridden in subsequent blocks.

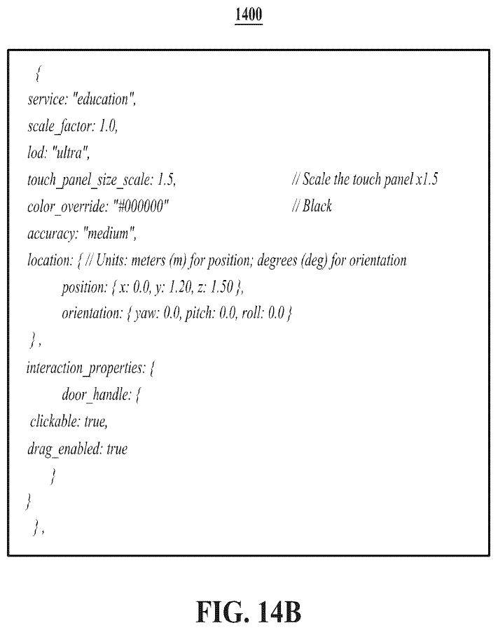

Referring to FIG. 13, a parameter 1300 of “environment_specific [. . . ]” defined in the “payload” field 1000 of FIG. 10 is illustrated as an example. The parameter 1300 shown in FIG. 13 is only an example for description, and embodiments are not limited thereto.

“environment_specific [. . . ]” may include aligned entries applicable to operating environments such as AR, VR, digital twins, or metaverse.

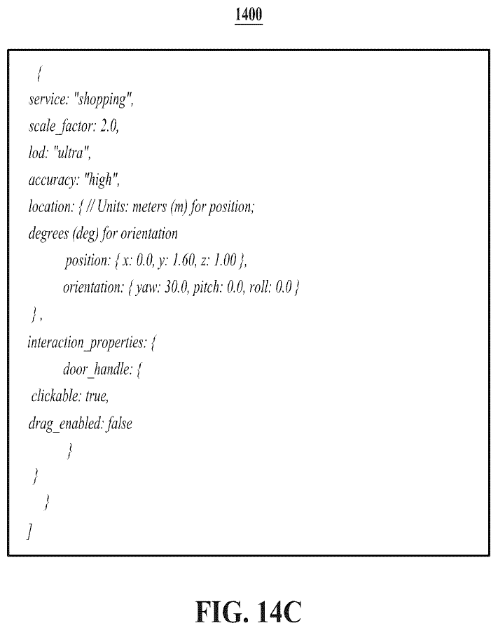

Referring to FIGS. 14A to 14C, a parameter 1400 of “service_specific [. . . ]” defined in the “payload” field 1000 of FIG. 10 is illustrated as an example. In the present disclosure, FIGS. 14A to 14C are illustrated as separate drawings but may represent one parameter 1400. The parameter 1400 shown in FIG. 14 is only an example for description, and embodiments are not limited thereto.

“service_specific [. . . ]” may include aligned entries applicable to related metaverse services such as industrial maintenance assistance, shopping, or education.

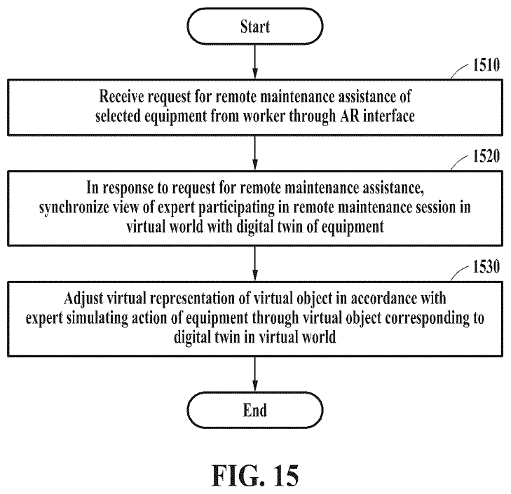

FIG. 15 is a flowchart illustrating a method of operating a metaverse system for remote maintenance assistance, according to an embodiment.

In the following embodiments, operations may be performed sequentially but not necessarily. For example, the order of the operations may change, and at least two of the operations may be performed in parallel. Operations 1510 to 1530 may be performed by at least one component (e.g., a processor, etc.) of the metaverse system.

In operation 1510, the metaverse system may receive a request for remote maintenance assistance of selected equipment from a worker through an AR interface.

In operation 1520, in response to the request for remote maintenance assistance, the metaverse system may synchronize a view of an expert participating in a remote maintenance session in a virtual world with a digital twin of the equipment. The metaverse system may perform synchronization between an avatar of a worker, an avatar of an expert, and a digital twin. The metaverse system may apply a virtual task of a virtual object to the equipment after verification by the worker or expert is completed.

In operation 1530, the metaverse system may adjust a virtual representation of the virtual object according to simulation of an operation of the equipment performed by the expert through the virtual object corresponding to the digital twin in the virtual world. The metaverse system may adjust the size of the virtual object, or enlarge or modify the shape of the virtual object. The metaverse system may adjust the virtual representation of the virtual object by modifying virtual interface elements on the equipment. The metaverse system may adjust at least one of the size, color, shape, material, texture, transparency, animation behavior, physics simulation, sound, position, orientation, interaction, lighting, and sunlight response of the virtual object.

The metaverse system may reset the virtual object to its original state in response to the expert completing a diagnosis. The metaverse system may provide, in the virtual world, a maintenance situation in which the worker performs maintenance on the equipment for supervision by the expert to monitor, and provide corrective guidance of the expert according to the situation to the worker.

The descriptions provided with reference to FIGS. 1 to 14 may be applicable to each operation shown in FIG. 15, and thus, detailed descriptions thereof are omitted.

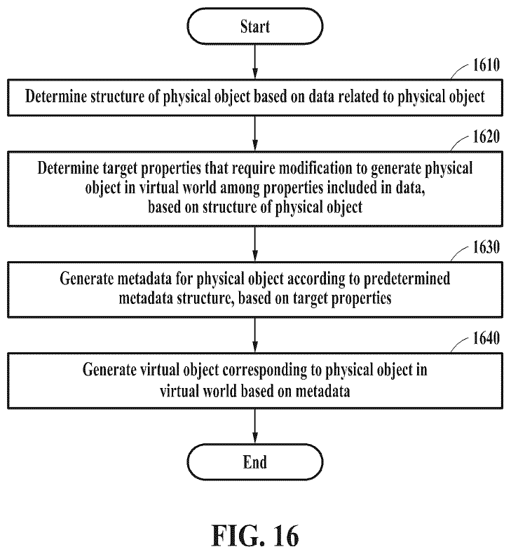

FIG. 16 is a flowchart illustrating a method of operating a metaverse system for generating a virtual object through metadata, according to an embodiment.

In the following embodiments, operations may be performed sequentially but not necessarily. For example, the order of the operations may change, and at least two of the operations may be performed in parallel. Operations 1610 to 1640 may be performed by at least one component (e.g., a processor, etc.) of the metaverse system.

In operation 1610, the metaverse system may determine a structure of a physical object based on data related to the physical object.

In operation 1620, the metaverse system may determine target properties that require modification to generate a virtual object, corresponding to the physical object, in a virtual world among properties included in the data, based on the structure of the physical object. The target properties may include at least one of the size, color, shape, material, texture, transparency, animation behavior, physics simulation, sound, position, orientation, interaction, lighting, and sunlight response of the physical object.

In operation 1630, the metaverse system may generate metadata for the physical object according to a predetermined metadata structure, based on the target properties.

In operation 1640, the metaverse system may generate a virtual object in the virtual world based on the metadata. The metaverse system may acquire target data related to a target physical object for which a virtual object is to be generated in the virtual world, and, based on the metadata, change values of the target properties of the target data to generate a virtual object corresponding to the target physical object. The metaverse system may determine whether at least some of the properties included in the target data correspond to properties included in the metadata, and in response to determining that at least some of the properties included in the target data correspond to properties included in the metadata, generate a virtual object. The metaverse system may generate the virtual object by changing values of the target properties of the target data or determining the values of the target properties based on predetermined reference values, based on the metadata.

The descriptions provided with reference to FIGS. 1 to 15 may be applicable to each operation shown in FIG. 16, and thus, detailed descriptions thereof are omitted.

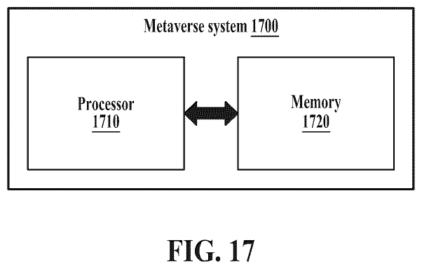

FIG. 17 is a block diagram of a metaverse system according to an embodiment.

Referring to FIG. 17, a metaverse system 1700 may include a processor 1710. The processor 1710 may include at least one processor. Additionally, the metaverse system 1700 may further include memory 1720.

The memory 1720 may store instructions (e.g., programs) executable by the processor 1710. For example, the instructions may include instructions for executing an operation of the processor 1710 and/or an operation of each component of the processor 1710.

The processor 1710 may be a device that executes instructions or programs, or controls the metaverse system 1700, and may include, for example, various processors such as a central processing unit (CPU) and a graphics processing unit (GPU). The processor 1710 may receive a request for remote maintenance assistance of selected equipment from a worker through an AR interface. In response to the request for remote maintenance assistance, the processor 1710 may synchronize a view of an expert participating in a remote maintenance session in a virtual world with a digital twin of the equipment. The processor 1710 may adjust a virtual representation of a virtual object according to simulation of an operation of the equipment performed by the expert through the virtual object corresponding to the digital twin in the virtual world.

The processor 1710 may adjust the size of the virtual object, or enlarge or modify the shape of the virtual object. The processor 1710 may adjust a virtual representation of the virtual object by modifying virtual interface elements on the equipment. The processor 1710 may adjust at least one of the size, color, shape, material, texture, transparency, animation behavior, physics simulation, sound, position, orientation, interaction, lighting, and sunlight response of the virtual object. The processor 1710 may perform synchronization between a an avatar of a worker, an avatar of an expert, and a digital twin. The processor 1710 may apply a virtual task of the virtual object to the equipment after verification by the worker or expert is completed. The processor 1710 may reset the virtual object to its original state in response to the expert completing a diagnosis. The processor 1710 may provide, in the virtual world, a maintenance situation in which the worker performs maintenance on the equipment for supervision by the expert to monitor, and provide corrective guidance of the expert according to the situation to the worker.

The processor 1710 may determine a structure of the physical object based on data related to the physical object. The processor 1710 may determine target properties that require modification to generate a virtual object, corresponding to the physical object, in the virtual world among properties included in the data, based on the structure of the physical object. The processor 1710 may generate metadata for the physical object according to a predetermined metadata structure, based on the target properties. The processor 1710 may generate the virtual object in the virtual world based on the metadata.

The processor 1710 may acquire target data related to a target physical object for which a virtual object is to be generated in the virtual world, and, based on the metadata, change values of the target properties of the target data to generate a virtual object corresponding to the target physical object. The processor 1710 may determine whether at least some of the properties included in the target data correspond to properties included in the metadata, and in response to determining that at least some of the properties included in the target data correspond to properties included in the metadata, generate a virtual object. The processor 1710 may generate the virtual object by changing values of the target properties of the target data or determining the values of the target properties based on predetermined reference values, based on the metadata. The target properties may include at least one of the size, color, shape, material, texture, transparency, animation behavior, physics simulation, sound, position, orientation, interaction, lighting, and sunlight response of the physical object.

In addition, the metaverse system 1700 may process the operations described above.

The components described in the examples may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the examples may be implemented by software, and the software may be recorded on a recording medium. The components, the functions, and the processes described in the examples may be implemented by a combination of hardware and software.

The embodiments described herein may be implemented using a hardware component, a software component, and/or a combination thereof. A processing device may be implemented using one or more general-purpose or special-purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and generate data in response to execution of the software. For purpose of simplicity, the description of a processing device is singular; however, one of ordinary skill in the art will appreciate that a processing device may include a plurality of processing elements and a plurality of types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be stored in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The method according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher-level code that may be executed by the computer using an interpreter.

The above-described hardware devices may be configured to act as one or more software modules in order to perform the operations of the above-described embodiments, or vice versa.

As described above, although the embodiments have been described with reference to the limited drawings, one of ordinary skill in the art may apply various technical modifications and variations based thereon. For example, suitable results may be achieved if the described techniques are performed in a different order, and/or if components in a described system, structure, device, or circuit are combined in a different manner, and/or replaced or supplemented by other components or their equivalents.

Therefore, other implementations, other embodiments, and equivalents to the claims are also within the scope of the following claims.

What is claimed is:

1. A method of operating a metaverse system, the method comprising:
receiving a request for remote maintenance assistance of selected equipment from a worker via an augmented reality (AR) interface;
in response to the request for remote maintenance assistance, synchronizing a view of an expert participating in a remote maintenance session in a virtual world with a digital twin of the equipment; and
adjusting a virtual representation of a virtual object according to simulation of an operation of the equipment performed by the expert through the virtual object corresponding to the digital twin in the virtual world.

2. The method of claim 1, wherein the adjusting of the virtual representation of the virtual object comprises:
adjusting a size of the virtual object, or enlarging or modifying a shape of the virtual object.

3. The method of claim 1, wherein the adjusting of the virtual representation of the virtual object comprises:
adjusting the virtual representation of the virtual object by modifying virtual interface elements for the equipment.

4. The method of claim 1, wherein the adjusting of the virtual representation of the virtual object comprises:
adjusting at least one of size, color, shape, material, texture, transparency, animation behavior, physics simulation, sound, position, orientation, interaction, lighting, and sunlight response of the virtual object.

5. The method of claim 1, wherein the synchronizing of the view of the expert with the digital twin of the equipment comprises:
performing synchronization between an avatar of the worker, an avatar of the expert, and the digital twin.

6. The method of claim 1, wherein the synchronizing of the view of the expert with the digital twin of the equipment comprises:
applying a virtual operation for the virtual object to the equipment, after confirmation of the worker or the expert is completed.

7. The method of claim 1, further comprising:
in response to the expert completing a diagnosis, resetting the virtual object to its original state.

8. The method of claim 1, further comprising:
providing, in the virtual world, a maintenance situation in which the worker performs maintenance on the equipment for supervision by the expert; and
providing corrective guidance of the expert according to the situation to the worker.

9. A method of operating a metaverse system, the method comprising:
determining a structure of a physical object, based on product data related to the physical object;
determining target properties that require modification to generate a virtual object, corresponding to the physical object, in a virtual world among properties included in the product data, based on the structure of the physical object;
generating metadata related to the physical object according to a predetermined metadata structure, based on the target properties; and
generating the virtual object in the virtual world, based on the metadata.

10. The method of claim 9, wherein the generating of the virtual object comprises:
acquiring target data related to a target physical object for which the virtual object is to be generated in the virtual world; and
generating the virtual object corresponding to the target physical object by changing values of the target properties of the target data, based on the metadata.

11. The method of claim 10, wherein the generating of the virtual object comprises:
determining whether at least a portion of properties included in the target data correspond to properties included in the metadata; and
in response to determining that at least a portion of the properties included in the target data correspond to properties included in the metadata, generating the virtual object.

12. The method of claim 10, wherein the generating of the virtual object comprises:
generating the virtual object by changing values of the target properties of the target data, or by determining values of the target properties as predetermined reference values, based on the metadata.

13. The method of claim 9, wherein the target properties comprise at least one of size, color, shape, material, texture, transparency, animation behavior, physics simulation, sound, position, orientation, interaction, lighting, and sunlight response of the physical object.

14. A metaverse system comprising:
a processor; and
memory storing instructions that, when executed by the processor, cause the metaverse system to:
receive a request for remote maintenance assistance of selected equipment from a worker via an augmented reality (AR) interface,
in response to the request for remote maintenance assistance, synchronize a view of an expert participating in a remote maintenance session in a virtual world with a digital twin of the equipment, and
adjust a virtual representation of a virtual object according to simulation of an operation of the equipment performed by the expert through the virtual object corresponding to the digital twin in the virtual world.

15. The metaverse system of claim 14, wherein the instructions, when executed by the processor, cause the metaverse system to:
adjust a size of the virtual object, or enlarge or modify a shape of the virtual object.

16. The metaverse system of claim 14, wherein the instructions, when executed by the processor, cause the metaverse system to:
adjust the virtual representation of the virtual object by modifying virtual interface elements for the equipment.

17. The metaverse system of claim 14, wherein the instructions, when executed by the processor, cause the metaverse system to:
adjust at least one of size, color, shape, material, texture, transparency, animation behavior, physics simulation, sound, position, orientation, interaction, lighting, and sunlight response of the virtual object.

18. The metaverse system of claim 14, wherein the instructions, when executed by the processor, cause the metaverse system to:
perform synchronization between an avatar of the worker, an avatar of the expert, and the digital twin.

19. The metaverse system of claim 14, wherein the instructions, when executed by the processor, cause the metaverse system to:
apply a virtual task for the virtual object to the equipment, after confirmation of the worker or the expert is completed.

20. The metaverse system of claim 14, wherein the instructions, when executed by the processor, cause the metaverse system to:
in response to the expert completing a diagnosis, reset the virtual object to its original state.
